(19) United States
(12) Patent Application Publication
(10) Pub. No.: US 2023/0129800 A1
(43) Pub. Date: Apr. 27, 2023

(54) TRAY FOR CAR

(71) Applicant: Yanan Zeng, Shenzhen (CN)

(72) Inventor: Yanan Zeng, Shenzhen (CN)

(21) Appl. No.: 17/527,019

(22) Filed: Nov. 15, 2021

(30) Foreign Application Priority Data
Oct. 25, 2021 (CN) 202122574669.X

(51) Int. Cl. B60N 3/00

(52) U.S. Cl. CPC B60N 3/002

(57) ABSTRACT

A tray for a car includes a support body, detachably connected to a central console of the car; a first container, detachably connected to one end of the support body; and a second container, detachably connected to the other end of the support body.

### CROSS-REFERENCE TO RELATED APPLICATIONS

This patent application claims priority to CHINESE patent application Number CN 202122574669.X, which was filed on Oct. 25, 2021, which is incorporated herein by reference in its entirety, and the priority benefits of which are hereby claimed.

### FIELD OF THE INVENTION

This patent application relates generally to car accessories, and more particularly to a tray for a car.

### BACKGROUND OF THE INVENTION

With continuous improvement of people's living standards, vehicles and other transport have become consumers necessities. It may sometimes be necessary to place a working surface near the driver and/or any passenger inside the vehicle, such as, for example, to place portable items such as mobile phones, e-cigarettes, sunglasses, power banks, and the like, upon a working surface. Therefore, many modern vehicle interior designs are configured to provide working surfaces at various locations in passenger compartments, such as setting trays on the center console. However, existing trays on the market are usually permanently fixed on the central console. When users do not need to use them, they cannot be removed from the central console, which not only occupies design space inside the vehicle, but also easily interferes with the seat, resulting in the driver and/or passengers unable to adjust the seat to a suitable position. Therefore, there is an urgent need to provide a tray for cars, which can be easily and quickly moved to and supported on the central console inside the vehicle, and when the user does not need to use the tray, the tray can be easily removed in whole or in part from the central console, so as to prevent the tray from occupying space inside the vehicle and avoid interference between the tray and the seat, thereby improving user experience.

### SUMMARY OF THE INVENTION

In order to solve above problems or difficulties, the present disclosure provides a tray for a car, which can be easily and quickly moved to and supported on the central console inside the vehicle, and when the user does not need to use the tray, the tray can be easily removed in whole or in part from the central console, so as to prevent the tray from occupying space inside the vehicle and avoid interference between the tray and the seat, thereby improving user experience.

The present disclosure provides a tray for a car. The tray includes a support body, detachably connected to a central console of the car; a first container, detachably connected to one end of the support body; and a second container, detachably connected to the other end of the support body.

In at least one embodiment, the first container and/or the second container is provided with a first hanging part configured to carry storage bag.

In at least one embodiment, the first hanging part is arranged on a side of the first container or a side of the second container.

In at least one embodiment, the first container and/or the second container is provided with a second hanging part configured to carry storage bag.

In at least one embodiment, the second hanging part is arranged on a side of the first container or a side of the second container.

In at least one embodiment, the support body is provided with a first slot, the first container is provided with a first insert block detachably inserted in the first slot.

In at least one embodiment, the support body is provided with a first stop piece, a second stop piece is arranged adjacent to the first slot, when the first insert block is detachably inserted in the first slot, the first stop piece resists against the second stop piece so as to keep the first insert block in the first slot.

In at least one embodiment, the support body is provided with a second slot, the second container is provided with a second insert block detachably inserted in the second slot.

In at least one embodiment, the second container is provided with a third stop piece, a fourth stop piece is arranged adjacent to the second slot, when the second insert block is detachably inserted in the second slot, the third stop piece resists against the fourth stop piece so as to keep the second insert block in the second slot.

In at least one embodiment, the support body is provided with a third slot, the second container is provided with a third insert block detachably inserted in the third slot.

In at least one embodiment, the support body is provided with a first accommodating cavity, a first partition is arranged in the first accommodating cavity to divide the first accommodating cavity into a first accommodating unit and a second accommodating unit.

In at least one embodiment, the first container is provided with a second accommodating cavity, a second partition is arranged in the second accommodating cavity to divide the second accommodating cavity into a third accommodating unit and a fourth accommodating unit.

In at least one embodiment, the second container is provided with a third accommodating cavity, a third partition is arranged in the third accommodating cavity to divide the third accommodating cavity into a fifth accommodating unit and a sixth accommodating unit.

A tray for a car includes a support body, detachably connected to a central console of the car; a first container, connected to one end of the support body; and a second container, connected to the other end of the support body.

The tray provided by the present disclosure includes the support body, the first container and the second container. The support body is configured to be detachably connected with the central console of the vehicle. The first container is detachably connected with one end of the support body, and the second container is detachably connected with the other end of the support body, so that when the user needs to use the tray to place articles on the central console of the vehicle, the support body of the tray can be detachably connected to the central console of the vehicle to realize installation of the tray.

Moreover, when the user does not need to use the tray, the support body of the tray can be separated from the central console to separate the tray from the central console, so as to prevent the tray from occupying space inside the vehicle. Further, since the first container is detachably connected with one end of the support body and the second container is detachably connected with the other end of the support body, when the user needs to adjust the seat, the tray wholly or the first container and/or the second container can be separated from the support body, so as to effectively avoid interference between the tray and the seats, which is convenient for adjusting positions of the seats, thereby greatly improve user experience.

### BRIEF DESCRIPTIONS OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic view of a tray according to an embodiment of the present disclosure, the tray including a support body, a first container, and a second container;

FIG. 2 is a schematic view showing the support body connected with a center console of a car;

FIG. 3 is an exploded view of the tray of FIG. 1 from a first view;

FIG. 4 is an exploded view of the tray of FIG. 1 from a second view;

FIG. 5 is a cross-sectional view of the tray of FIG. 1 taken along a first slot on the support body and a first insert block on the first container;

FIG. 6 is an enlarged view of the portion A identified in FIG. 5;

FIG. 7 is an enlarged view of the portion B identified in FIG. 5;

FIG. 8 is a cross-sectional view of the tray of FIG. 1 taken along a first stop piece on the first container and a second stop piece adjacent to the first slot;

FIG. 9 is an enlarged view of the portion C identified in FIG. 8; and

FIG. 10 is an enlarged view of the portion D identified in FIG. 8.

### DETAILED DESCRIPTION OF THE ILLUSTRATED EMBODIMENT

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the invention, “a plurality of” means two or more, unless otherwise specifically defined.

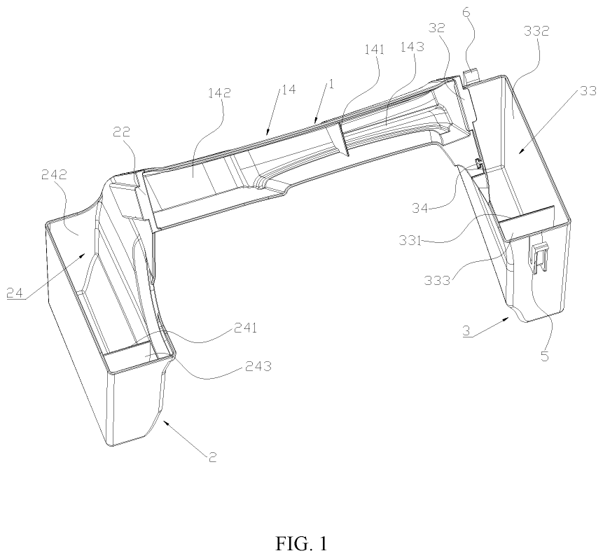

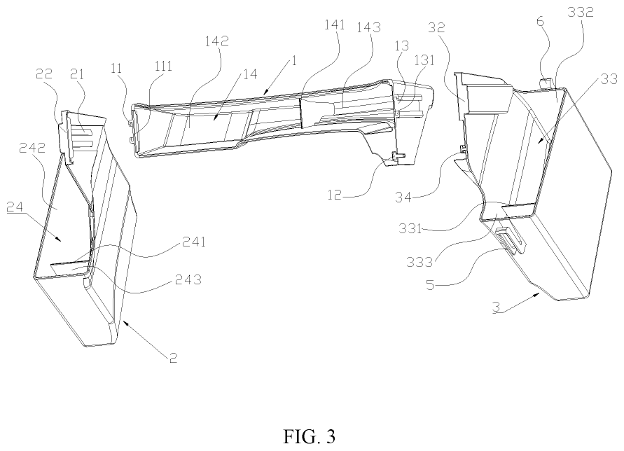

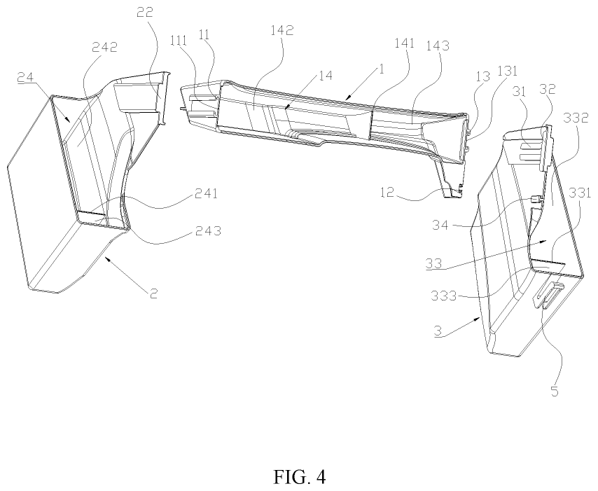

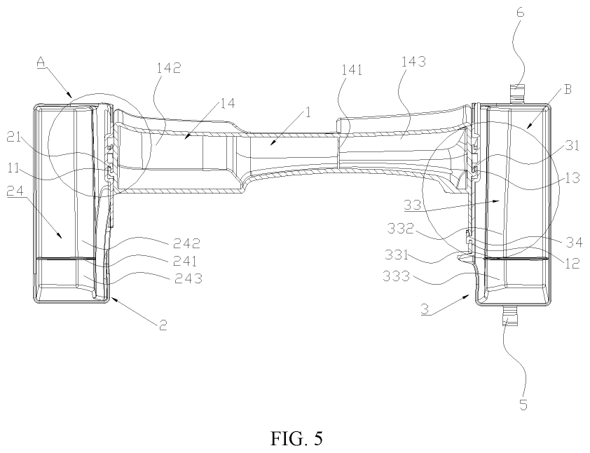

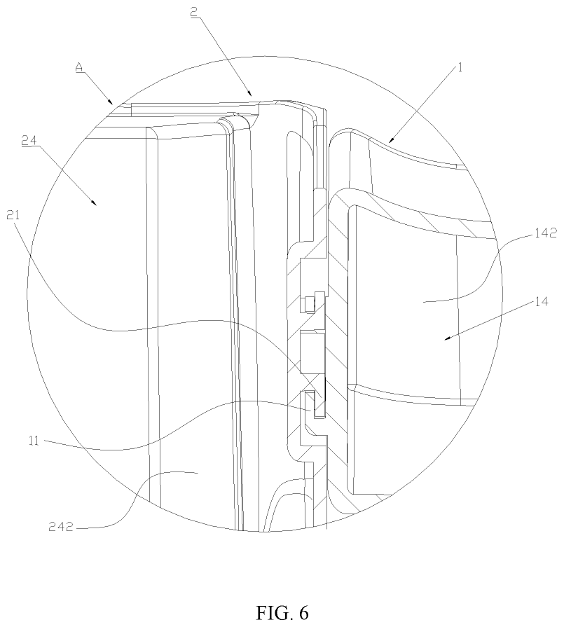

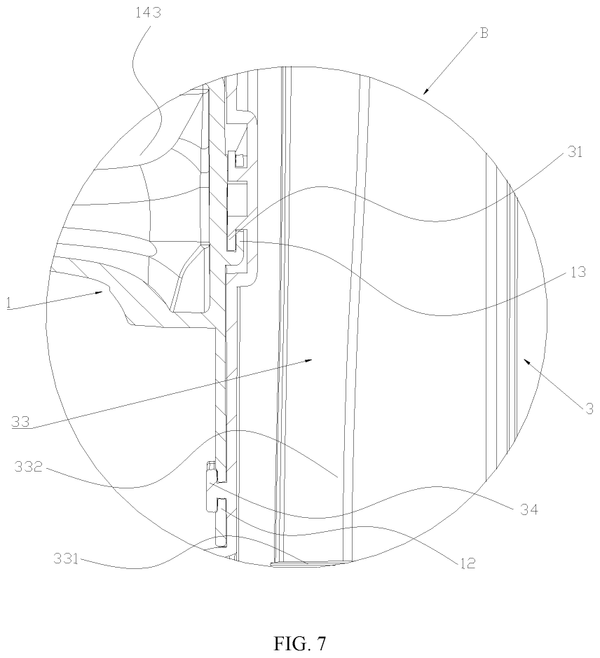

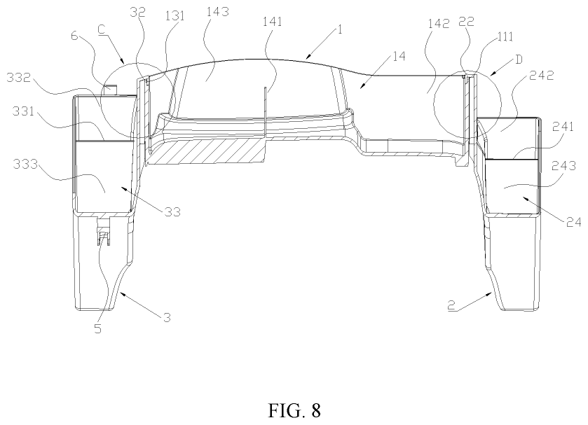

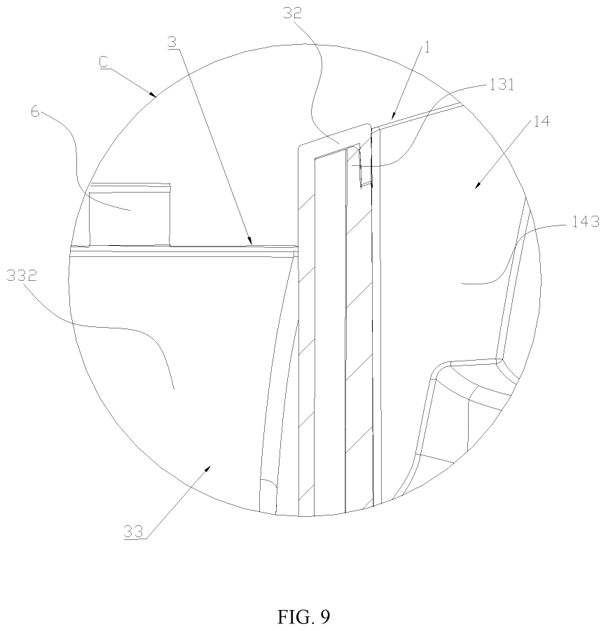

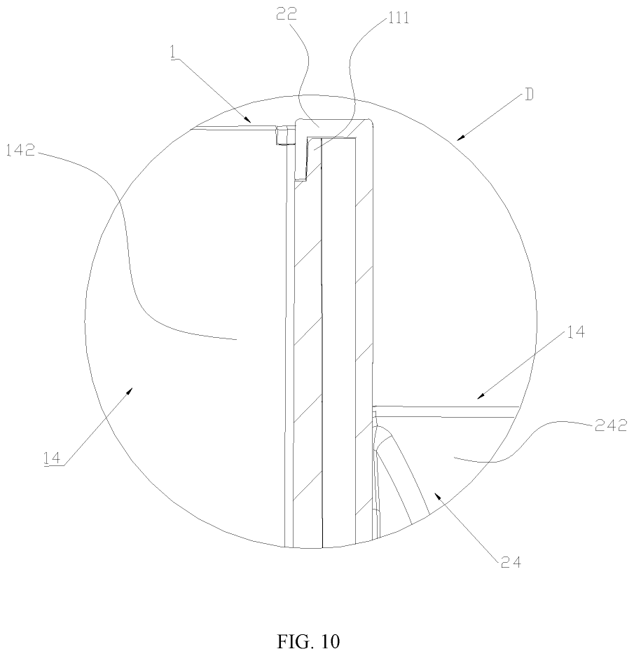

Referring to FIGS. 1-10, a tray provided by an embodiment of the present disclosure is used for a car. The tray includes a support body 1, a first container 2 and a second container 3. The support body 1 is configured to be detachably connected to a center console 4 of the car. The first container 2 is detachably connected to one end of the support body 1, and the second container 3 is detachably connected to the other end of the support body 1.

Through above arrangements, the tray includes the support body, the first container and the second container. The support body is configured to be detachably connected with the central console of the vehicle. The first container is detachably connected with one end of the support body, and the second container is detachably connected with the other end of the support body, so that when the user needs to use the tray to place articles on the central console of the vehicle, the support body of the tray can be detachably connected to the central console of the vehicle to realize installation of the tray. Moreover, when the user does not need to use the tray, the support body of the tray can be separated from the central console to separate the tray from the central console, so as to prevent the tray from occupying space inside the vehicle. Further, since the first container is detachably connected with one end of the support body and the second container is detachably connected with the other end of the support body, when the user needs to adjust the seat, he can choose to remove the tray wholly or separate the first container and/or the second container from the support body, so as to effectively avoid interference between the tray and the seat. It is convenient for users to adjust the seat to a suitable position, which greatly improves user experience.

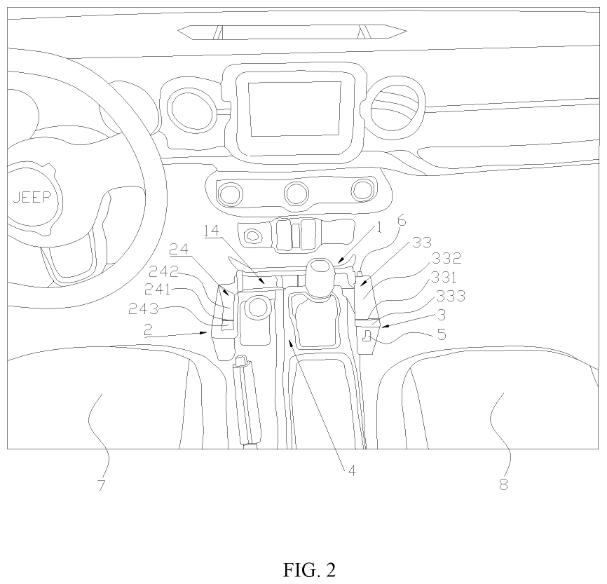

Referring to FIG. 2, the central console is located between the driver's seat 7 and the passenger's seat 8, the first container 2 is arranged close to the driver's seat 7, and the second container is arranged close to the passenger's seat 8, so that the driver on the driver's seat 7 can place the articles on the first container 2 of the tray, and the passenger on the passenger's seat 8 can place the articles on the second container 3 of the tray. Specifically, when the driver wants to adjust a position of the driver's seat 7, the entire tray can be removed from the central console, or the first container can be removed from the support body to prevent interference between the first container of the tray and the seat, so as to facilitate the driver on the driver's seat 7 to adjust the position of the driver's seat 7; Further, when the position of the co driver's seat 8 is to be adjusted, the entire tray can be removed from the central console, or the second container can be removed from the support body to prevent interference between the second container of the tray and the seat, so that the passenger located on the passenger's seat 8 can adjust the position of the co driver's seat 8. Further, since the first container is detachably connected with one end of the support body and the second container is detachably connected with the other end of the support body, it is easy to separate the first container and the second container from the support body, so as to facilitate packing, carrying and transportation of the tray, so that the tray can be more easily distributed to the user, which greatly saves transportation cost of the tray.

In at least one embodiment, the support body can be directly placed on the central console to achieve detachable connection between the support body and the central console. The support body can be attached to the center console through adhesive material such as double-side adhesive tap to achieve detachable connection between the support body and the central console. The support tray can be made of plastic, rubber, metal or carbon fiber. In at least one embodiment, the support tray is a plastic tray, and the plastic tray is coated or suffered from other surface treatments to make the tray more beautiful. Specifically, the support body can also be configured to be retractable, so that the support body can be matched with central console of different sizes, so that the tray can be applicable for central console of various cars.

In at least one embodiment, the first container 2 and/or the second container 3 is provided with a first hanging part 5 configured to carry storage bag. The first container 2 and/or the second container 3 is further provided with a second hanging part 6 configured to carry storage bag. In detail, the storage bag can be a garbage bag or other storage bag for storing other items. The first hanging part 5 and the second hanging part 6 can be arranged on two opposite sides of the first container. Alternatively, the first hanging part 5 and the second hanging part 6 can be arranged on two opposite sides of the second container. Optionally, the first hanging part 5 and the second hanging part 6 can be arranged on the first container and the second container respectively. The driver on the driver's seat and/or the passenger on the passenger's seat can hang storage bags on the first hanging part 5 and/or the second hanging part 6, so that the driver and/or the passenger can put garbage or other items into the storage bags. It is reasonable in design, simply in structure, stable in connection, and convenient for replacing storage bags.

In at least one embodiment, the support body 1 is provided with a first slot 11, the first container 2 is provided with a first insert block 21 configured to be detachably inserted in the first slot 11. The first container 2 is provided with a first stop piece 22, a second stop piece 111 is arranged adjacent to the first slot 11. When the first insert block 21 is detachably inserted into the first slot 11, the first stop piece 22 resists against the second stop piece 111, so as to prevent the first block from moving out of the first slot 11. Through such arrangements, it is reasonable in design, simple in structure, stable in connections, which effectively achieves a detachable connection between the first container and the support body. When the first insert block is detachably inserted into the first slot, the first stop piece resists against the second stop piece so as to prevent the first insert block from moving out of the first slot, which can effectively keep the first insert block inside the first slot so as to prevent the first container from separating from the support body. When the user wants to remove the first container from the support body, the first container can be removed from the support body by pushing the first insert block from the first slot in a direction away from the second stop piece.

In at least one embodiment, the support body 1 is further provided with a second slot 13. The second container 3 is provided with a second insert block 31 configured to be detachably inserted in the second slot 31. The second container 3 is provided with a third stop piece 32, a fourth stop piece 131 is arranged adjacent to the second slot 31. When the second insert block 31 is detachably inserted into the second slot 31, the third stop piece 32 resists against the fourth stop piece 131, so as to prevent the second insert block from moving out of the second slot 31. The support body 1 is further provided with a third slot 12, the second container 3 is provided with a third insert block configured to be detachably inserted in the third slot 12.

Through such arrangements, it is reasonable in design, simple in structure, stable in connections, which effectively achieves a detachable connection between the second container and the support body. When the second insert block is detachably inserted into the second slot, the third stop piece resists against the fourth stop piece so as to prevent the second insert block from moving out of the second slot, which can effectively keep the second insert block inside the second slot so as to prevent the second container from separating from the support body. In addition, the third insert block is detachably inserted in the third slot, which enhance a connection between the second container and the support body. When the user wants to remove the second container from the support body, the second container can be removed from the support body by pushing the second insert block from the second slot in a direction away from the fourth stop piece and separating the third insert block from the third slot.

In at least one embodiment, the support body 1 is provided with a first accommodating cavity 14, and a first partition is arranged in the first accommodating cavity 14 to divide the first accommodating cavity 14 into a first accommodating unit 142 and a second accommodating unit 143. The first container 2 is provided with a second accommodating cavity 24, and a second partition is arranged in the second accommodating cavity 24 to divide the second accommodating cavity 24 into a third accommodating unit 242 and a fourth accommodating unit 243. The second container 3 is provided with a third accommodating cavity 33, and a third partition 331 is arranged in the third accommodating cavity 33 to divide the third accommodating cavity 33 into a fifth accommodating unit 332 and a sixth accommodating unit 333. Through such arrangements, the user can put different items into the first accommodating unit, the second accommodating unit, the third accommodating unit, the fourth accommodating unit, the fifth accommodating unit, and the sixth accommodating unit respectively. For example, the user can put sun glasses into the first accommodating unit, put a chargeable power bank into the second accommodating unit, put a mobile phone into the third accommodating unit or the fifth accommodating unit, put an electric cigarette into the fourth accommodating unit or the sixth accommodating unit.

Still referring to FIGS. 1-10, an embodiment of the present disclosure provides the try for a car, which includes the support body 1, a first container 2 and the second container 3. The support body 1 is configured to be detachably connected to the central console 4 of the car, the first container 2 is connected to one end of the support body, and the second container 3 is connected to the other end of the support body.

Through such arrangements, the tray includes the support body, the first container and the second container. The support body is configured to be detachably connected with the central console of the vehicle. The first container is detachably connected with one end of the support body, and the second container is detachably connected with the other end of the support body, so that when the user needs to use the tray to place articles on the central console of the vehicle, the support body of the tray can be detachably connected to the central console of the vehicle to realize installation of the tray. Moreover, when the user does not need to use the tray, the support body of the tray can be separated from the central console to separate the tray from the central console, so as to prevent the tray from occupying space inside the vehicle. Further, since the first container is detachably connected with one end of the support body and the second container is detachably connected with the other end of the support body, when the user needs to adjust the seat, the tray wholly or the first container and/or the second container can be separated from the support body, so as to effectively avoid interference between the tray and the seats, which is convenient for adjusting positions of the seats, thereby greatly improve user experience. Furthermore, the central console is located between the driver's seat and the passenger's seat, the first container is adjacent to the driver's seat, the second container is adjacent to the passenger's seat, so that the driver on the driver's seat can put items in the first container, and the passenger on the passenger's seat can put items in the second container.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed as new and desired to be protected by Letters Patent, is:

1. A tray for a car comprising:
a support body, detachably connected to a central console of the car;
a first container, detachably connected to one end of the support body; and
a second container, detachably connected to the other end of the support body.

2. The tray according to claim 1, wherein:
the first container and/or the second container is provided with a first hanging part configured to carry storage bag.

3. The tray according to claim 2, wherein:
the first hanging part is arranged on a side of the first container or a side of the second container.

4. The tray according to claim 2, wherein:
the first container and/or the second container is provided with a second hanging part configured to carry storage bag.

5. The tray according to claim 4, wherein:
the second hanging part is arranged on a side of the first container or a side of the second container.

6. The tray according to claim 1, wherein:
the support body is provided with a first slot, the first container is provided with a first insert block detachably inserted in the first slot.

7. The tray according to claim 6, wherein:
the support body is provided with a first stop piece, a second stop piece is arranged adjacent to the first slot, when the first insert block is detachably inserted in the first slot, the first stop piece resists against the second stop piece so as to keep the first insert block in the first slot.

8. The tray according to claim 1, wherein:
the support body is provided with a second slot, the second container is provided with a second insert block detachably inserted in the second slot.

9. The tray according to claim 8, wherein:
the second container is provided with a third stop piece, a fourth stop piece is arranged adjacent to the second slot, when the second insert block is detachably inserted in the second slot, the third stop piece resists against the fourth stop piece so as to keep the second insert block in the second slot.

10. The tray according to claim 9, wherein:
the support body is provided with a third slot, the second container is provided with a third insert block detachably inserted in the third slot.

11. The tray according to claim 1, wherein:
the support body is provided with a first accommodating cavity, a first partition is arranged in the first accommodating cavity to divide the first accommodating cavity into a first accommodating unit and a second accommodating unit.

12. The tray according to claim 1, wherein:
the first container is provided with a second accommodating cavity, a second partition is arranged in the second accommodating cavity to divide the second accommodating cavity into a third accommodating unit and a fourth accommodating unit.

13. The tray according to claim 1, wherein:
the second container is provided with a third accommodating cavity, a third partition is arranged in the third accommodating cavity to divide the third accommodating cavity into a fifth accommodating unit and a sixth accommodating unit.

14. A tray for a car, comprising:
a support body, detachably connected to a central console of the car;
a first container, connected to one end of the support body; and
a second container, connected to the other end of the support body.
